(19) United States
(12) Patent Application Publication
(10) Pub. No.: US 2012/0308966 A1
(43) Pub. Date: Dec. 6, 2012

(54) Network based method to link a self assessment and 3rd party evaluations to performance development through eLearning and online training recommendations as well as coaching proposals and advice

(76) Inventor: Hellen Davis, Treasure Island, FL (US)

(21) Appl. No.: 13/151,407

(22) Filed: Jun. 2, 2011

(51) Int. Cl. G09B 19/18

(52) U.S. Cl. 434/107

(57) ABSTRACT

An integrated method for managing employee and/or personal development through an individual's, 3^{rd} party interested respondent's, or team member's evaluation, including pre- and post-learning testing, which then provides the specific linkages for recommendations, eLearning, coaching, and reevaluation in a continuous cycle. All data is provided in a web-based environment through real time and instantaneous distribution of appropriate recommendations. Testing and assessing the difference between the current level of skill and/or behavioral competency and desired level is completed by respondents and their counterparts (if desired). Responses to the documents are accepted on the web site. After the responses have been accepted, these are processed into a report with online learning (eLearning), coaching, and training recommendations tied to the results of the learning and behavioral gaps determined through the evaluation process as appropriate. This report is returned to an interested party.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to a method of delivering services over the Internet. More specifically the present invention relates to a network based method to link a self-assessment and 3^{rd} party evaluations to performance development through eLearning and online training recommendations as well as coaching proposals and advice.

### BACKGROUND OF THE INVENTION

Employee surveying or assessment firms sell, or license, or otherwise market, employee opinion or assessment forms and employee evaluation systems to other businesses. In the usual manner, these assessment vehicles and tools are distributed and sold to businesses that utilize the forms or methodology to evaluate their employees and/or potential hires. The distribution network or firm may process and analyze the forms and assessment tool for the various businesses or the business purchase software or rights to process same. Employee assessment forms and tools are usually either sold to the businesses through a network of independent contractors/distributors or through a sales force employed by the employee assessment firms.

Employee assessment firms' primary function is to assess the employee but they do not provide eLearning recommendations, online training or provide online coaching recommendations linked to the results based on the self and/or 3^{rd} party assessment reports. In addition to not providing an eLearning platform, these firms lack the systems necessary to link current versus desired competency requirements and provide a suite of eLearning programs to deliver appropriate targeted eLearning recommendations to the respondents. As such, the employee assessment firms provide little or no significant guidance regarding the steps necessary to increase said employee or individual's level of competency through providing the appropriate online training, eLearning, or coaching recommendations plus providing instantaneous access to a comprehensive suite of training products made instantly available with recommendations tailored to each individual with the express goal of closing the gap between current and desired behavioral know-how, performance screen, capability and skill set, job proficiency, and behavioral aptitude based on the self, versus 3^{rd} party assessment gaps highlighted in the assessment report.

At present, in the assessment of the field, this methodology is non-existent in a real time environment, through a web-based systematic approach. Through evaluation certain proprietary information is embodied in the system and methodology that are subsequently sold to businesses and individuals in a licensing format or usage agreement. The assessments that businesses do utilize at present also are often not utilized efficiently because after assessment, employees are not provided sufficient guidance in how to increase their knowledge or effectiveness. They are assessed and provided the knowledge but as often as not this is where the process ends. The knowledge from the tool most often becomes ‘shelfware’ rather than providing a useful means of propelling learning and competency.

There is a need in the art for a method which allows an employee firm—after the employee has been evaluated—to easily determine the most effective way of providing online training and eLearning sessions, as well as personal and professional development sessions and tools to employees or individuals without having to seek the services of an expert, consultant, or coach; which is often cost prohibitive. With this system it is possible to significantly eliminate the current high costs associated with training and employee development recommendations. It is estimated that the cost savings in the realm of 80-90% for the majority of firms utilizing a combination of assessment tools, individual development evaluation, onsite coaching, and traditional in-classroom training In addition, there is a need in the art for a method which allows employee or individual evaluation tied instantly to a training and development plan. This invention provides this system. This provides firms greater control over their employee training and development costs.

### SUMMARY OF THE INVENTION

The present invention is an integrated method for managing a participant's and/or employee's development through an individual's or team's evaluation, including pre- and post-learning testing, which then provides the specific linkages for recommendations, eLearning, coaching, and reevaluation in a continuous cycle. All data is provided in a web-based environment through real time and instantaneous distribution of appropriate recommendations. Testing and assessing the difference between the current level of skill and/or behavioral competency and desired level is completed by respondents and their counterparts (if desired). Responses to the documents are accepted on the web site. After the responses have been accepted, these are processed into a report with online learning (eLearning), coaching, and training recommendations tied to the results of the learning and behavioral gaps determined through the evaluation process as appropriate. This report is returned to an interested party.

All recommendations for online training, coaching, or eLearning are directly tied to the results of an individual's or team's evaluation through a proprietary method of sorting the learning and performance criteria includes the step of displaying the recommendation and associated documents on a web site. Such criteria is based upon current competencies versus desired competencies (in the performance and behavior facets of the individual's proficiency) by providing access to documents over a wide area comprising: (a) providing an respondents' input document or testing tool or instrument for completion by respondents desiring recommendations for eLearning, online training, and/or coaching.

It is to be understood that the response vehicle or tool, surveys or other forms to be completed by users could be filled out on paper manually and the results could then be entered into a computer and sent to the web site, or completed on the web-site by the respondents. The reports could be electronically transmitted, and/or hard copies sent via mail, facsimile, overnight delivery, regular mail services, hand delivered, or through other modes. Through evaluation certain proprietary information is embodied in the system and methodology that are subsequently sold to businesses and individuals in a licensing format or usage agreement.

It is a primary object of the present invention to provide an eLearning and online-based document/reporting distribution method that solves problems and deficiencies in the art and fundamentally provides a systematic way of tying self-assessment and/or 3^{rd} party evaluation and testing to training and eLearning recommendations in real time to enhance employee and personal effectiveness—closing the gap between current and desired competencies through an organization, social circle, or family group.

It is a further object of the present invention to provide a document or reporting distribution method, which reduces the cost associated with providing the customized recommendations for online training, coaching, or eLearning tied to the results for current competencies versus desired competencies of each individual respondent by providing real time instantaneous access to documents and web-based materials guiding their eLearning through the web-based eLearning system.

It is a further object of the present invention to provide a method of document, eLearning, training, online training, and performance system distribution, which enables an employee, individual, master distributor, distributor, or firm to retain more control over its reporting, documents, forms, employee recommendations, eLearning and training methodologies.

Yet another object of the present invention is to provide a method of document eLearning, training, online training, and performance system distribution which assures that more evaluations are completed by employees over a period of time and that these periodic evaluations are not lost before a trend or pattern of competency impact can be determined. Historic information provides a basis for continuous improvement throughout the organization.

It is a further object of the present invention to provide a document distribution method which allows an employee's company, social circle, or family group better access to a wide array of instantaneously updated reports and eLearning programs and products to lower training and deliver costs.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart of the method of the present invention;

FIG. 2 is an illustrated screen shot showing the method of distributing documents including the step of displaying the documents on a web site;

FIG. 3 is an illustrated screen shot of the re-assessment self-perception created by the method of the present invention;

FIG. 4 is an illustrated screen shot of the re-assessment self-perception created by the method of the present;

FIG. 5 is an illustrated screen shot of the re-assessment third party perception created by the method of the present invention;

FIG. 6 is an illustrated screen shot of the re-assessment third party perception created by the method of the present invention;

FIGS. 7a and 7b are illustrated screen shots of exemplary 3^{rd} party output generated by the method of the present invention; and

FIG. 8 is an illustrated screen shot of e-learning recommendations generated by the method of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

The present invention relates to a systematic way of providing and managing the distribution and collection of specific documents and materials over a wide area or a network such as the Internet by providing recommendations for online training, coaching recommendations, or eLearning recommendations tied to the results for current competencies versus desired competencies as they relate to the respondent's goals and assessment results by providing access to documents comprising: (a) providing an respondents' input document or testing tool or instrument for completion by respondents desiring recommendations for eLearning, online training, and/or coaching recommendations. The present invention also relates to a method of doing business over the Internet through providing the company and its affiliates with access to the system and subsequent recommendations as well as the eLearning platform for delivery.

The present invention is an integrated method for managing an individual's and/or employee development through evaluation, recommendations, eLearning, coaching, and reevaluation. All data is provided in a web-based environment through real time and instantaneous distribution and updating of appropriate assessments, results, and recommendations. All recommendations for online training, coaching, or eLearning are directly tied to the results of an individual's or team's self assessment and/or 3^{rd} party evaluations through a proprietary method of sorting the assessment and evaluation criteria. Such criteria is based upon current behavior competencies versus desired and/or perceived behavior competencies (in the performance and behavior facets of the individual's proficiency) by providing access to documents over a wide area comprising: (a) providing an respondents' self assessment input document or testing tool or instrument as well as various 3^{rd} party input documents and tools for completion by respondents desiring recommendations for eLearning, online training, and/or coaching recommendations. Through evaluation certain proprietary information is embodied in the system and methodology that are subsequently sold to businesses and individuals.

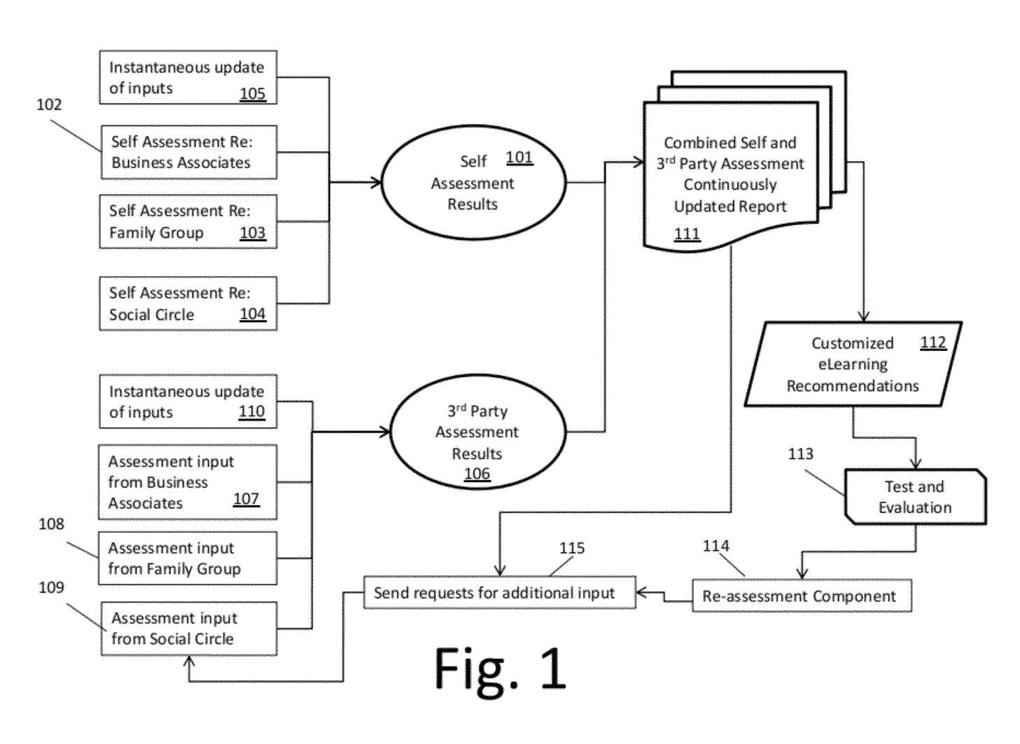

Now referring to FIG. 1, the method of the present invention is illustrated. Self-assessment results 101 are generated by the collective input of self-assessments from a business perspective through business associates 102, family members' point of view 103, a social circle or friends' vantage point 104, and instantaneous update of inputs are generated 105. 3^{rd} party assessment results 106 are generated by the collective input of self-assessments from business associates 107, family groups 108, and social circles 109, and instantaneous updates of inputs 110. The combined self-assessment results 101 and 3^{rd} party results 106 are combined to generate a report 111, which is continuously updated as assessment results are gathered and updated. The report 111 includes the customized eLearning recommendations 112 generated by the method of the present invention and provides a test and evaluation 113 for confirming the attainment or completion of additional learning or the need for the suggested learning. A re-assessment component 114 provides a means for re-evaluating and determining if the recommendations are still valid and correct or if changes need to be made. The combined self-assessment results 101 and 3^{rd} party results 106 and generated report 111 may generate requests for additional input 115 from either of the collective inputs, from the individual (self) 102, 103, 104 and or 3^{rd} parties 107, 108, 109 to update results from the individual (self) 101 or 3^{rd} parties 106.

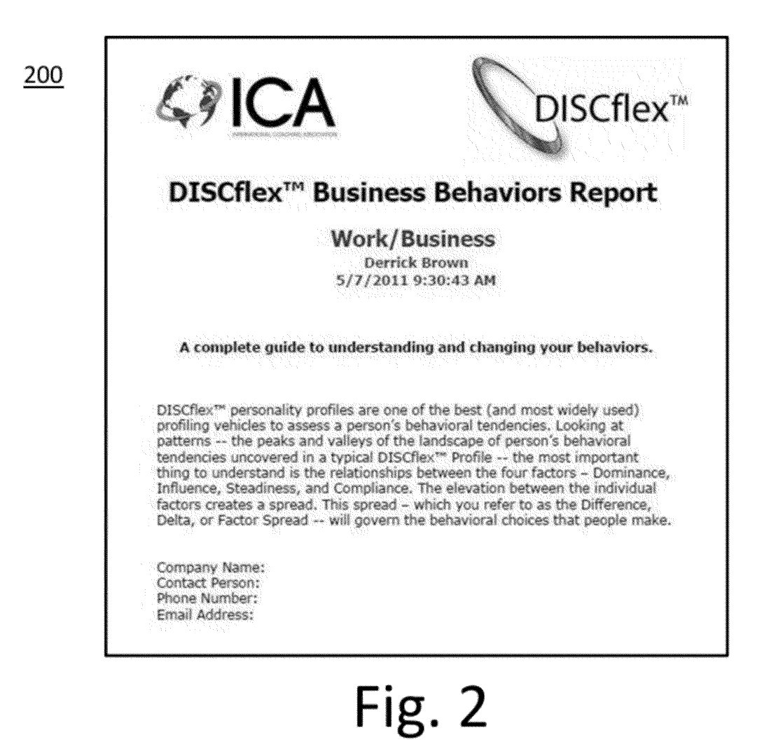

A method of distributing documents includes the step of displaying the documents on a web site 200 as shown in FIG. 2. Responses to the documents are accepted on the web site 200. After the responses have been accepted, they are processed into a report and the report complete with recommendations is returned to an interested party. It is to be understood that the surveys or other forms to be completed by users could be filled out on paper manually and the results could then be entered into a computer and sent to the web site. The reports could be electronically transmitted, and/or hard copies sent via mail, facsimile overnight, or through other delivery methods or modes.

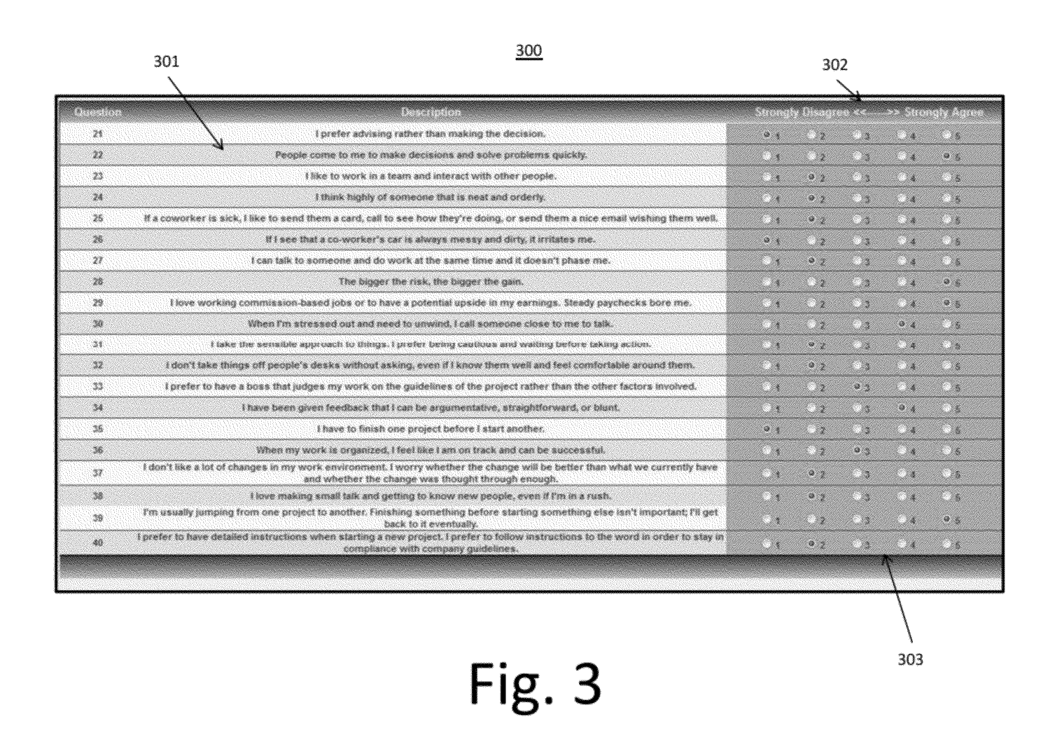

Now referring to FIG. 3, an illustrated screen shot of the re-assessment self-perception 300 created by the method of the present invention is shown. In this step, the user answers a plurality of questions 301 about their own self-perception. Typically the questions are present in the format of the user providing an answer on a scale of 1-5 302 with corresponds to the user either disagreeing, agreeing, or being neutral on the question/statement presented about themselves in the answer box 303.

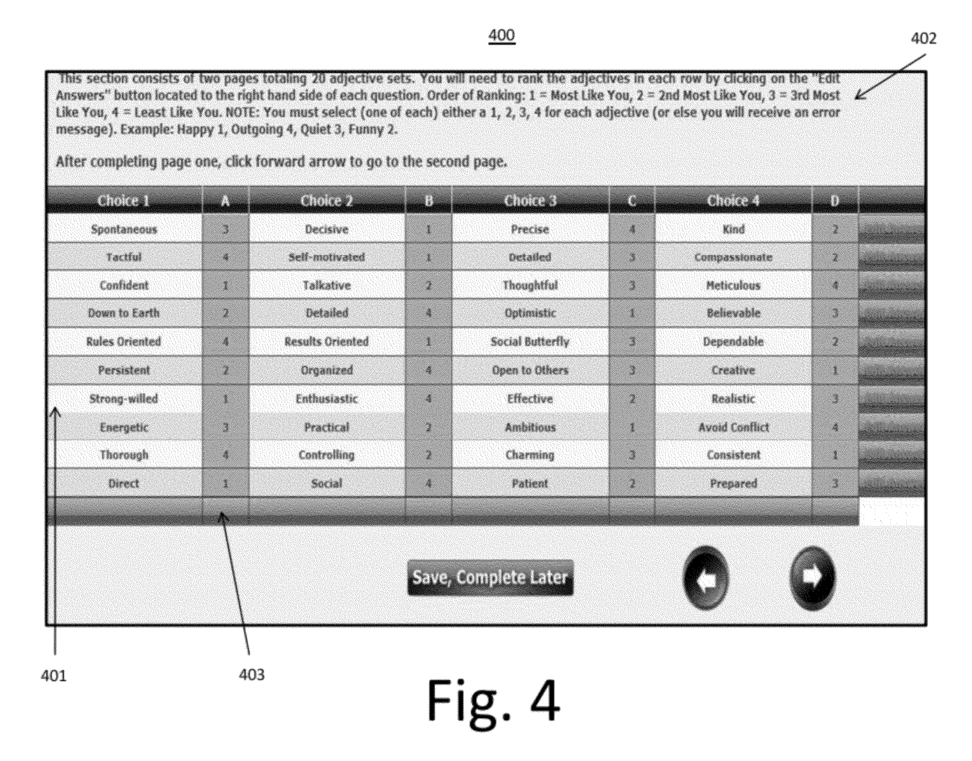

Now referring to FIG. 4 an illustrated screen shot of the re-assessment self-perception 400 created by the method of the present invention is shown. In this step, the user answers a plurality of questions 401 about their own self-perception. Typically the questions are present in the format of the user providing an answer on a forced ranking scale of 1-4 402 which corresponds to the user ranking from most to least presented about the descriptive words about themselves in the answer box 403

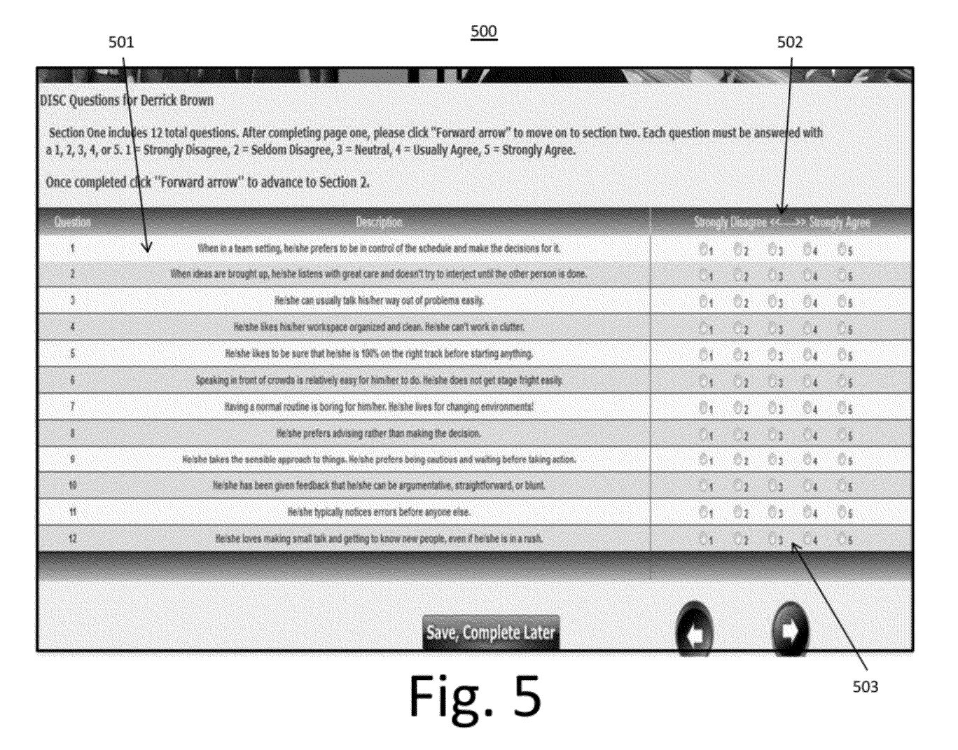

Now referring to FIG. 5 an illustrated screen shot of the re-assessment third party perception 500 created by the method of the present invention is shown. In this step, the third party in any of the realms of business associate, social circle or family member answers a plurality of questions 501 about their perception of the participant/user. Typically the questions are present in the format of the third party providing an answer on a scale of 1-5 502 which corresponds to the third party either disagreeing, agreeing, or being neutral on the question/statement presented about the participant/user in the answer box 503.

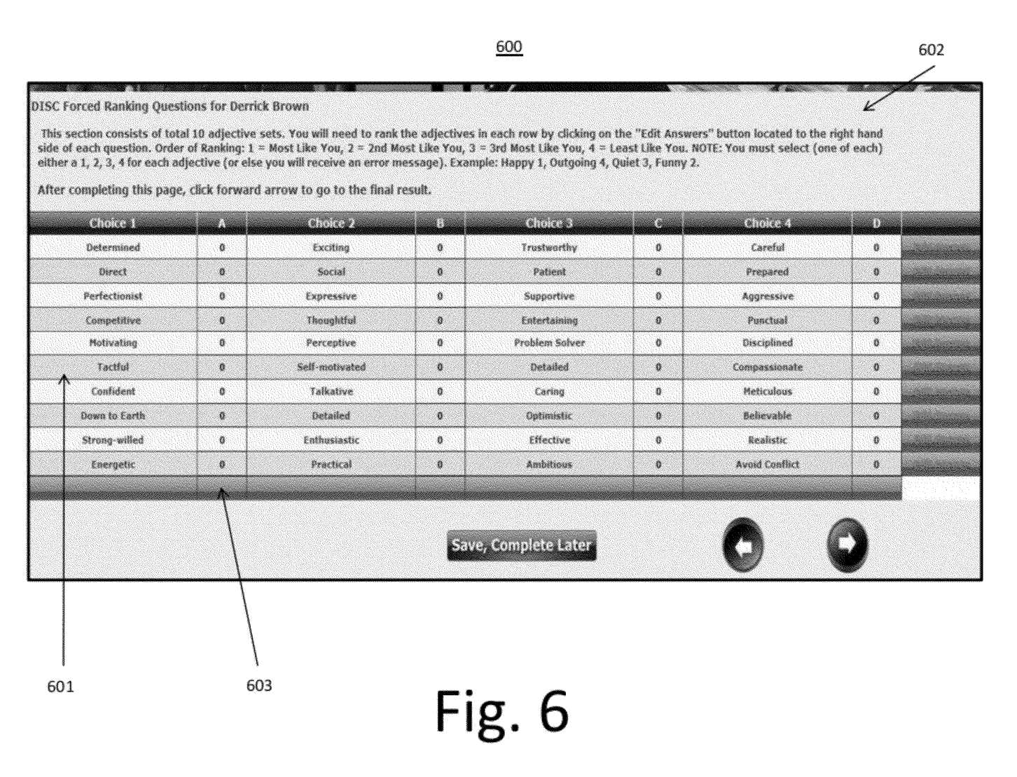

Now referring to FIG. 6 an illustrated screen shot of the re-assessment third party perception 600 created by the method of the present invention is shown. In this step, the third party in any of the realms of business associate, social circle or family member answers a plurality of questions 601 about their third party perception of the participant/user. Typically the questions are present in the format of the third party providing an answer on a forced ranking scale of 1-4 602 which corresponds to the third party's perception of the participant/user ranking from most to least presented about the descriptive words about the participant/user in the answer box 603

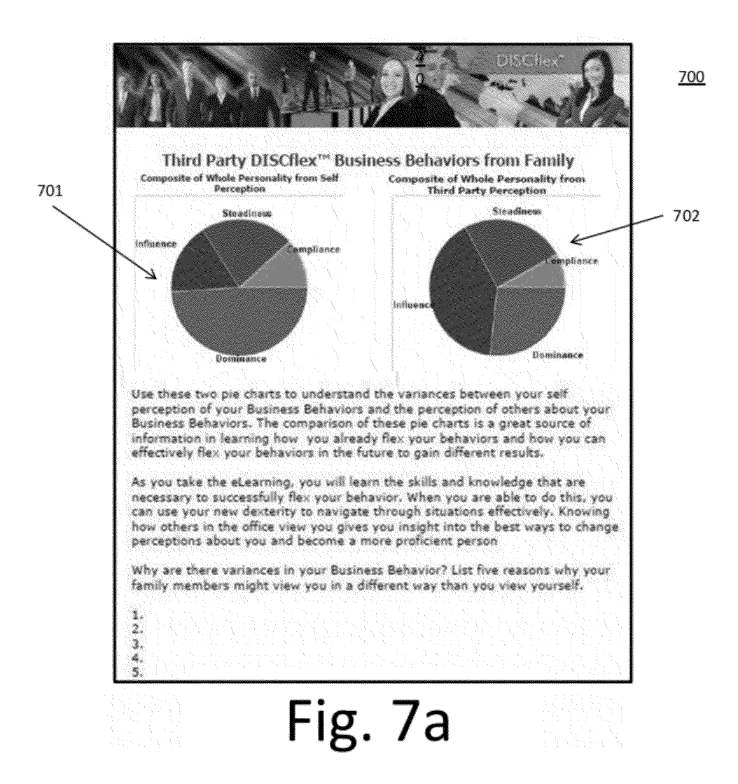

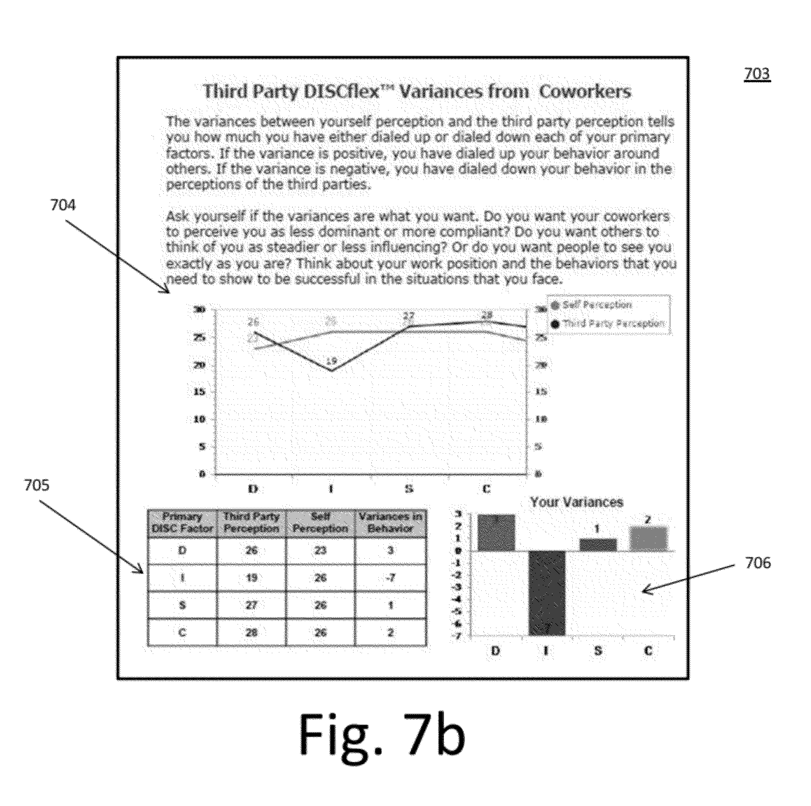

FIG. 7a is an illustrated screen shot 700 of exemplary 3^{rd} party output generated by the method of the present invention. In one embodiment, one or more pie charts 701 and 702 may be used as shown in this example to show a composite of self-perception of behaviors compared to those taken or expressed by a third party. This comparison provides a resource for the user to visually see the difference in their self-perception of their business behaviors or any behavior being measured, compared to that of a 3^{rd} party, such as co-workers in this example so that the user can learn how they are behaving, how their behavior is being viewed by others, and how they can adjust or change their behavior in the future to obtain a different result or external appearance.

FIG. 7b is an illustrated screen shot 703 of exemplary 3^{rd} party output generated by the method of the present invention. In one embodiment, one or more line graphs 704 may be used as shown in this example to show a composite of self-perception of behaviors compared to those taken or expressed by a third party. This comparison provides a resource for the user to visually see the difference in their self-perception of their business behaviors or any behavior being measured, compared to that of a 3^{rd} party, such as co-workers in this example so that the user can learn how they are behaving, how their behavior is being viewed by others, and how they can adjust or change their behavior in the future to obtain a different result or external appearance. Additionally, a matrix 705 is included to illustrate the values of the self-perception behavior and the values of the of self-perception of behaviors compared to those taken or expressed by a third party with respect to the factors and the variances between the two values, which are then illustrated in an bar graph 706.

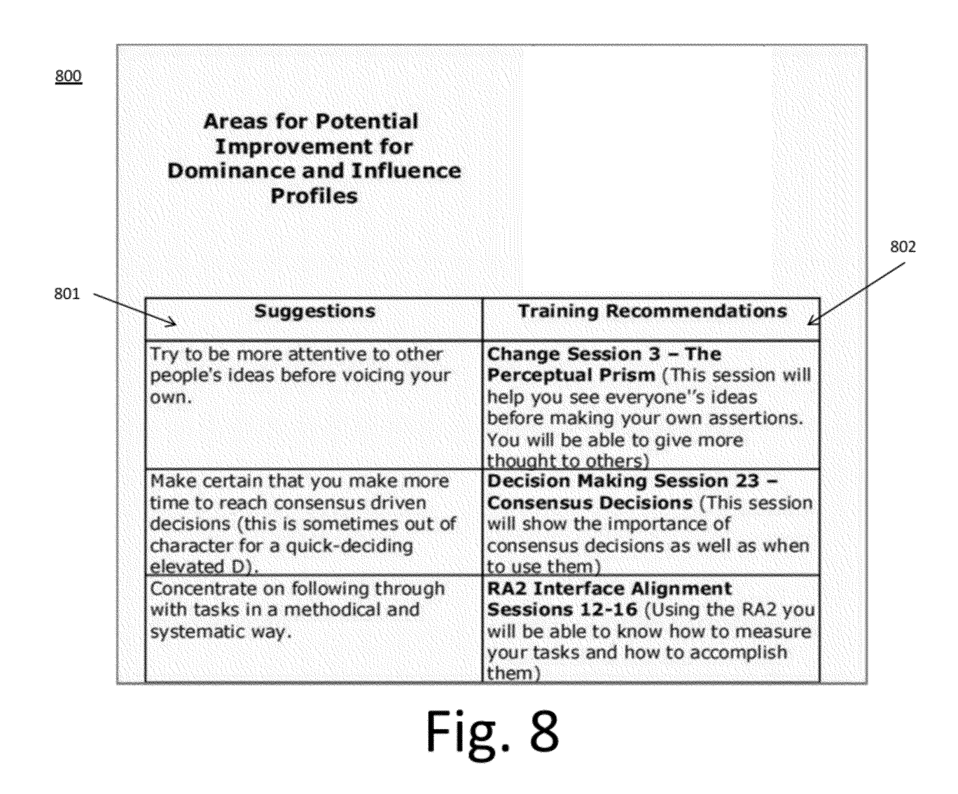

FIG. 8 is an illustrated screen shot of e-learning recommendations generated by the method of the present invention. The present invention generates the report 800 shown in FIG. 8 which contains one or more suggestions with respect to behavior 801 with complementary training and/or eLearning recommendations 802 for each of the suggestions. This allows a user to receive not only suggested behavior modifications, but provides them with the correct, corresponding training and/or eLearning that can be undertaken to learn, practice, or otherwise understand the training and/or eLearning necessary or available to assist them in acting upon the suggestions.

In an alternative embodiment of the invention provides control over access and/or distribution to and/or from a web site. This access or distribution of documents and forms is performed by administration of passwords or similar access restrictions. The present invention can also include a method of providing employee evaluation services. The method of providing employee evaluation services includes providing employee evaluation forms on a web site. Responses to the evaluation forms are also accepted on a web site. After the responses have been accepted, the responses, or reports based on the responses are returned to an employer of the employee or to the individual or other the entity has granted viewing rights to regarding the resulting recommendations.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method to link a self-assessment and 3^{rd} party evaluations to performance and/or personal development through eLearning and online training recommendations as well as coaching proposals and advice, capable of execution on a computer, comprising the steps of:
assigning a password for a respondent;
initializing a set of permissions relative to the password;
providing an evaluation instrument which gauges an individual's current core competency level based on self-assessment and the input from the assessment of 3^{rd} party respondents in the areas of work, social and family relationships, considers future desired competency levels;
determining or measuring the gaps in perception between self and 3^{rd} party assessment regarding same;
providing recommendations, after determinations are made, for the appropriate method or a combination of methods selected from the group containing:
further data gathering,
eLearning suggestions,
online training references, or
coaching suitability with regards to a particular job, an individual's performance or behavior with regards to their competency for a particular job, or an individual boss's performance with regards to a particular job to a respondent after verification of the password;
evaluating a team leader's performance and individual team member's performance as it relates to the process or system;
receiving responses from the respondent to the evaluation instrument;
processing the responses into an evaluation report; and
sending the evaluation report to one or more locations authorized by the set of permissions associated with the password.

2. The method of claim 1, further comprising the steps of managing real time recommendations for online training, coaching, or eLearning tied to the results of assessment evaluation criteria; and
creating an instantaneous distribution of appropriate recommendations for online training, coaching, or eLearning tied to the results of assessment evaluation criteria.

3. The method of claim 1 wherein the permissions associated with a master distributor level of rights include
creating respondent links and passwords;
setting up new accounts;
managing reports;
changing its own and others' account options; an
viewing the entity's constituent's individual reports and connections throughout the network, as well as input from all 3^{rd} party respondents;
providing support, coaching, and customer service as it pertains to the recommendations report for access to online training, coaching recommendations, or eLearning; and
setting up new distributor level accounts.

4. The method of claim 1 wherein the permissions associated with a distributor level of rights include
creating respondent links and passwords;
setting up new accounts;
managing reports;
changing its own and others' account options;
viewing the entity's constituent's individual reports and connections throughout the network, as well as input from all 3^{rd} party respondents; and
providing support, coaching recommendations, and customer service as it pertains to the recommendations report for access to online training, coaching recommendations, or eLearning.

5. The method of claim 1 wherein the permissions associated with a company level of rights include
creating response links and passwords;
setting up new accounts;
managing reports;
changing account options;
viewing the entity's constituent's individual reports and connections throughout the network, as well as input from all 3^{rd} party respondents; and
providing support, coaching, and customer service as it pertains to the recommendations report for access to online training, coaching recommendations, or eLearning.

6. The method of claim 1 wherein the permissions associated with a client level of rights include creating response links and passwords;
managing reports; and
changing account options including individual passwords; ability to access passwords and account information through the ‘lost password’ functionality.

7. The method of claim 1 wherein the permissions associated with a respondent level of rights include
responding to an assigned evaluation instrument; and
viewing recommendations whenever permission is granted to do so.

8. The method of claim 1 wherein the permissions associated with a 3^{rd} party respondent level of rights include
Responding to an assigned evaluation instrument; and
viewing recommendations whenever permission is granted to do so.

9. A system for managing distribution of recommendations for online training, coaching recommendations, or eLearning, and current competencies versus desired competencies and their associated goals by providing access to documents and reports over a wide area comprising:
access a wide area network;
a central server or cloud server configuration;
software associated with the central server and cloud server configuration which administers a web site and which provides permissions;
a password having a set of permissions correlated to a respondent for an managing distribution of recommendations for online training, coaching recommendations, or eLearning tied to the results for current competencies versus desired competencies as they relate to the respondent's goals by providing access to documents and reports and recommendations over a wide area comprising evaluation survey which gauges an individual potential employee's suitability with regards to a particular behavior factor or characteristic or sub-factor, an individual existing perception of their competency with regard to skills, values and behaviors according to the expectations of the situation they are facing at work, at home, or in a social setting; and
a password having a set of permissions correlated to an entity interested in the respondent's responses to the assessment evaluation specifics.

10. The system of claim 9 wherein the recommendations provided relate to expected behavior and the 3^{rd} parties' assessment of the respondent's current level of competency, or personal performance of an individual.

11. The system of claim 9 wherein gathering of input data is completed either electronically or via hard copy.

12. The system of claim 9 wherein the process of providing recommendations data is completed either electronically or via hard copy.

13. The system of claim 9 wherein the set of permissions can vary from password to password depending on level of access granted to the web site and system.

14. A method to link a self-assessment and 3^{rd} party evaluations to performance and/or personal development through eLearning and online training recommendations as well as coaching proposals and advice comprising the steps of:
providing assessment embodied in the system and methodology that are subsequently sold to businesses and individuals;
and evaluation certain proprietary information is
Such criteria is based upon current competencies versus desired competencies in the performance and behavior facets of the individual's proficiency and based on respondent's goals;
providing access to documents over a wide area;
providing an respondents' input document or testing tool or instrument for completion by respondents desiring recommendations for eLearning, online training, and/or coaching;
assigning a password for an entity having a level of rights and/or access;
initializing permissions relative to the password based on the level of rights and/or access rights for the entity, said permissions including at least one respondent password having permissions based on the level of rights for a respondent and/or team of respondents;
allowing the entity access to a web site on a global computer network and enabling the initialized associated/granted permissions for the entity;
providing an assessment evaluation instrument to the respondent which provides immediate, real time recommendations for online training, coaching, or eLearning, and current competencies versus desired competencies gauges the most desirable eLearning and/or coaching methodologies to increase the respondents effectiveness in closing the gap between current and desired competence in a wide range of skills for business or life skills and based on respondent's goals;
receiving responses from the respondent to the assessment evaluation instrument;
providing an assessment evaluation instrument to the respondent's designated 3^{rd} party respondents which provides immediate, real time input as to the 3^{rd} parties' perceptions of the participant's behavior, characteristics and values;
processing the responses of the participant and the 3^{rd} party respondents instantaneously updated reports for recommendations and access to eLearning, online training, coaching, or other such insight stemming from assessment and evaluation; and
sending the recommendations report to one or more locations authorized by the associated permissions.
